(19) United States
(12) Patent Application Publication
(10) Pub. No.: US 2006/0119936 A1
(43) Pub. Date: Jun. 8, 2006

(54) Apparatus and method for color and polarization switching

(75) Inventor: Georg J. Ockenfuss, Santa Rosa, CA (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: JDS Uniphase Corporation, San Jose, CA (US)

(21) Appl. No.: 11/288,569

(22) Filed: Nov. 29, 2005

Related U.S. Application Data
(60) Provisional application No. 60/633,468, filed on Dec. 6, 2004.

(51) Int. Cl. G03B 21/56

(52) U.S. Cl. 359/443

(57) ABSTRACT

The invention relates to an apparatus and method for transforming white incident light into two mutually synchronized sequences of three colored light pulses over a frame interval, each light pulse having one of three primary color bands derived from the incident light, wherein only one of the three color bands is shared between the two color sequences, thereby providing all three paired combinations of the three color bands over the frame interval within the two light components. The two colored light sequences are used for illuminating two respective liquid-crystal-on-silicon imagers in a two-panel light engine to permit optimum active white balancing without reducing the duty cycle. A pure solid-state two-stage color and polarization switching apparatus is provided for generating the two colored light sequences using a combination of commercially available color/polarization filters and color/polarization switches.

### CROSS-REFERENCE TO RELATED APPLICATIONS

The present invention claims priority from U.S. Provisional Patent Application No. 60/633,468—filed Dec. 6, 2004 and entitled “2-stage color and polarization switch for 2-panel LCoS light engines”, and the contents thereof are incorporated herein by reference.

### FIELD OF THE INVENTION

In general, this invention relates to apparatuses and methods for producing sequentially colored image frames for two-panel light engines, and in particular to the use of color and polarization switches and filters for producing such image frames.

### BACKGROUND TO THE INVENTION

Light engine systems using two panels have several advantages over one-panel on one hand and three-panel systems on the other. The two-panel systems offer higher brightness than one-panel systems with simpler design than three-panel systems. Nevertheless, conventional two-panel systems are constrained by the use of switches that are spatially separated and at least one color wheel and this is likely to reduce the duty cycle. Every time the interface between two colors crosses the light beam, the imagers have to be turned off and this occurs typically at 10-15% of the time, depending on what kind of color wheel is used. In addition, white balancing would require a mechanical balancing of the color wheel which would present certain practical difficulties.

The approach described by Greenberg M: “Enhanced two-panel LCoS CMC”, OCL03-29, attempts to achieve white-point balancing the output of a light-engine without lowering the duty cycle by using a color wheel and an additional switch either as a second color wheel or as a liquid crystal switch. However, the use mechanical color wheels here, still presents various practical limitations.

In a previous invention of mine disclosed in Ockenfuss G: “2-Panel Light Engine for Projection Display Using LC-polarization Switch”, OCL04-21, I described a 2-panel light engine for projection display using one LC-polarization switch, in lieu of a color wheel. In this system, each panel sees two different colors, e.g. red and blue for one panel, and red and green for the other, in an attempt to meet the need of obtaining white-point balancing without sacrificing the duty cycle. I then discovered that this was only a necessity but not sufficient requirement to meet this need, and my system was unable to provide for true white balancing without reducing the duty cycle.

A two-panel projection system is disclosed by Robinson, et al. in U.S. Pat. No. 6,650,377 and by Chen et al. in Chen J, Robinson M G, and Sharp G: “Two-panel architecture for reflective LCD projector”, SID 01 Digest, p. 1084 (2001). This system uses a fully transmissive device with modifiable polarization stage for directing the red light to one panel and alternating blue and green lights to the other panel. Here stretch polymers are used as birefringent retarder plates. Still, no complete white balancing is possible with this approach, and the duty cycle is reduced, because one of the two panels is designated for the red channel only. Furthermore, this system requires a two-stage switch, which adds complexity but without necessarily adding functionality.

Alternatively, a color switch for use in two-panel projection systems is disclosed by Fuenfschilling et al. in U.S. Pat. No. 6,801,272, and by Bachels et al in Bachels T, Schmitt K, Funfschilling J, Stadlder M, Seiberle H, Schadt M: “Advanced Electronic Color Switch for Time-sequential Projection”, SID International Symposium, Sari Jose, (2001). The color switch in this system switches only between color bands but not between polarization modes. For this reason, it would not be possible to provide polarization-dependent separation between the two lights to be projected onto the two panels.

The above discussion clearly points to the need for a system that permits complete white balancing without reducing the duty cycle and without the use of mechanical color wheels.

### SUMMARY OF THE INVENTION

It is an object of the present invention to provide a pure solid-state color and polarization switching apparatus for use in two-panel light engines that permits optimum active white balancing without reducing the duty cycle. The switching apparatus is readily achievable through a combination of commercially available color/polarization filters such as those provided by Rolic Technologies Ltd and color/polarization switches such as those provided by ColorLink® Inc.

In a first aspect, the present invention there provides an optical apparatus transforming an incident light beam polarized in a first orientation of a first mode into a first light output dually polarized in the first orientation a second orientation of the first mode orthogonal to the first orientation, the incident light beam defining a first, a second and a third color band of the same polarization, the apparatus comprising:
a first filter of the retarder stack type for receiving the incident light beam, and transforming the first orientation of each of the second and third color bands into a second orientation essentially orthogonal to the first orientation;
a first switch comprising a liquid crystal transmissive device containing a plurality of liquid crystal switches for chromatically manipulating polarization, the transmissive device being positioned between a first and a second set of index-matched retarder layers, the first switch being disposed to receive light from the first filter, and being electronically switchable between a first state for retaining the orientation of all three color bands, and a second state for transforming the first orientation of the first color band into the second orientation, and the second orientation of the third color band into the first orientation;
a filtering assembly disposed to receive light from the first switch for transforming between the first and second orientations of each of the three color bands, while blocking the second orientation of the first color band, the filtering assembly comprising a second filter positioned between a first and a second polarization converter wherein the first polarization converter converts the first polarization mode of light received from the first switch into a second polarization mode, such that the first and second orientations of the first polarization mode are respectively transformed into mutually orthogonal third and fourth orientations of the second polarization mode, wherein the second filter blocks the fourth orientation of first color band; and wherein the second polarization converter reverts the second polarization mode into the first polarization mode, such that the third and fourth orientations are respectively transformed into the first and second orientations;
a second switch, comprising a liquid crystal switching element, disposed to receive light from the filtering assembly, the second switch being electronically switchable between a first state for retaining the orientation of all three color bands, and a second state for transforming between the first and second orientations of each of three color bands;
   wherein in operation, the first and second states of each of the first and second switches are synchronized such that the first light output follows a predetermined color and polarization sequence.

In a presently preferred embodiment, the optical apparatus further comprises:
a pair of color filters disposed to receive the first light output, for blocking the third and second color bands, thereby transmitting in combination a second light output having:
   the second color band polarized in the first orientation and the first color band in the second orientation when each of the first and second switches is in the first state thereof;
   the first color band polarized in the first orientation band and the third color band polarized in the second orientation band when the first switch is in the first state thereof and the second switch is in the second state thereof;
   the second color band polarized in the first orientation and the third color band in the second orientation band when the first switch is in the second state thereof and the second switch is the first state thereof;
splitting means disposed to receive the first light output, for splitting the first and second orientations thereof into a first and a second light component; and
means for white-point balancing by changing the amount of one of the three color bands relative to the other two color bands, independent of the ratio between the amounts of the other two color bands,
   wherein in operation the first and second switches are switched over a predetermined frame interval through three switching combinations of:
the first switch being in the first state thereof and the second switch in the first state thereof;
the first switch being in the first state thereof and the second switch in the second state thereof;
the first switch being in the second state thereof and the second switch in the first state thereof;
   thereby providing over the frame interval all three paired combinations of the first, second and third color bands within the first and second orientations of the light output.

Preferably the incident light beam is white light, the first, second and third color bands are substantially the red, green and blue primary color bands, the first polarization mode is linear with the first and second orientations being of p-type and s-type respectively, and the second polarization mode is circular with the third and fourth orientations being of left-handedness and right-handedness respectively. Conveniently the first filter is integrated with the first set of retarder layers into a single retarder stack, each of the first and second polarization converters is a quarter-wave plate, the second filter is a cholesteric color filter, the second set of retarder layers is integrated with the first polarization converter in a single retarder stack, and the pair of color filters are dichroic Yellow and Magenta color filters. Optionally the splitting means is one of a wire-grid type polarizing beam splitter and a polarizing beam splitting cube.

In a further aspect, there is provided a light engine comprising:
a projection lens
the above optical apparatus;
splitting means disposed to receive the second light output, for splitting the first and second orientations of into a first and a second light component.
a first and a second imager positioned to receive and individually modulate over the frame interval the first and second light components respectively, according to an applied image signal, thereby generating a first and a second modulated light beam;
means for directing the first and second modulated light beams into the projection lens;
at least one polarization filter to improve quality of the colored image; and
at least one analyzer to increase contrast of the colored image
   thereby creating within the frame interval a colored image corresponding to the image signal.

According to a further aspect of the present invention, there is provided a method for transforming an incident light beam over a predetermined frame interval into two sequentially colored light components polarized in mutually orthogonal orientations, the method comprising the steps of:
processing the incident light beam to form the two light components as two mutually synchronized sequences of three colored light pulses over the frame interval, each light pulse having one of three color bands derived from the incident light beam, wherein only one of the three color bands is shared between the two color sequences, thereby providing all three paired combinations of the three color bands over the frame interval within the two light components; and
providing means for white-point balancing by changing the amount of one of the three color bands relative to the other two color bands, independent of the ratio between the
amounts of the other two color bands.

The present invention enjoys the benefits of allowing active and dynamic white balancing at a higher duty cycle, with simplified and more compact light engine designs, requiring less space than color wheel, without a need for mechanically moving parts. The use of liquid crystal color switches, combined with various filter technologies, significantly increases the designers' ability to manage the display colors, thereby making this architecture more attractive than mechanical color wheels.

### BRIEF DESCRIPTION OF THE DRAWINGS

Exemplary embodiments of the invention will now be further described with references to the attached Figures in which same reference numerals designate similar parts throughout the figures thereof, and wherein:

FIG. 1 illustrates in a time chart, two color sequences produced over one frame interval, in accordance with an embodiment of the present invention;

FIG. 2 illustrates, in a block diagram, an optical apparatus for transforming a p-type linearly polarized incident light beam into a first light output dually polarized in p-type and s-type linear polarizations, in accordance with another embodiment of the present invention.

FIG. 3 illustrates in a table all four possible outcomes of the embodiment shown in FIG. 2 corresponding to all possible combined switching states thereof;

FIG. 4 further illustrates in a timing diagram the switching states of the embodiment shown in FIG. 2 and corresponding color and polarization states of the output light, over each of the three sub-frame intervals within one frame interval;

FIG. 5 illustrates one exemplary embodiment of a two-panel light engine making use of the optical apparatus embodiment illustrated in FIG. 2; and

FIG. 6 illustrates another exemplary embodiment of a two-panel light engine making use of the optical apparatus the embodiment illustrated in FIG. 2.

### DETAILED DESCRIPTION

Reference herein to any embodiment means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments.

The present invention addresses the limitations of prior art systems by providing a combination of commercially available color-polarization filters with color-polarization switches to create a pure solid-state flexible switch that allows optimum active white balancing without sacrificing the duty cycle.

Conventional 2-panel light engines employ 2 liquid-crystal-on-silicon (LCoS) imagers, where each imager is illuminated with sequences of image light pulses of different color bands typically selected from three primary color bands. The color bands are derived from a white light source, such as an arc lamp.

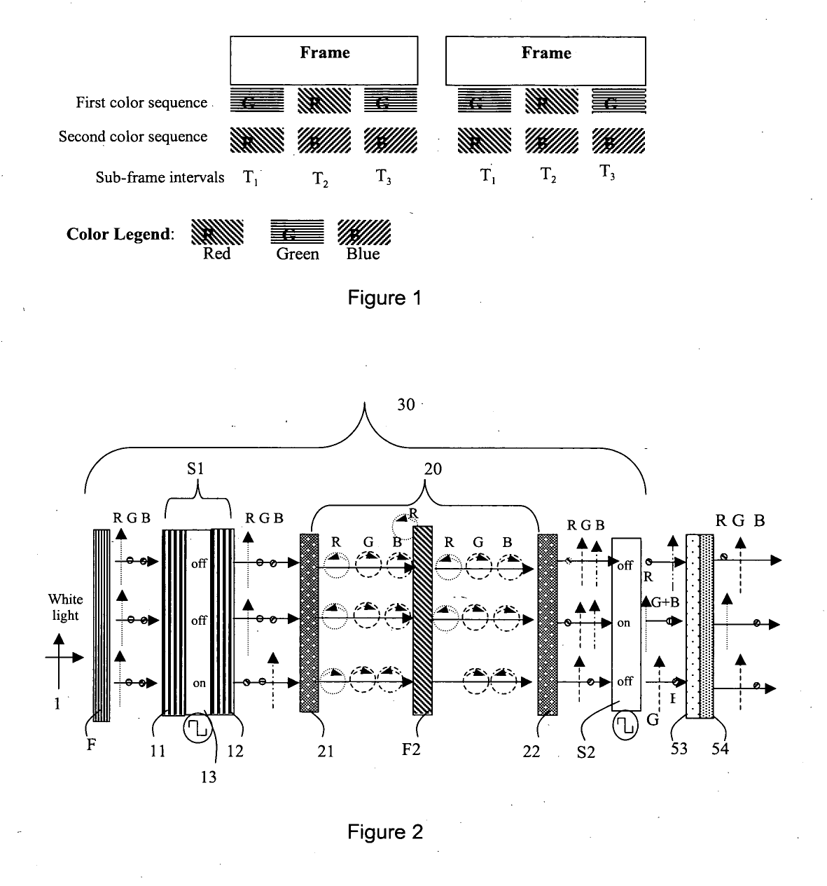

FIG. 1 illustrates in a time chart, the color sequences of two light components produced over one frame interval, in accordance with an embodiment of the present invention. The frame interval corresponds to one complete image to be perceived within one image frame. In this embodiment, the frame interval is divided into three sub-frame intervals T₁, T₂, and T₃. During each sub-frame interval, each of two color sequences is caused to contain one color selected from three primary color bands derived from an incident light beam. In this embodiment, the incident light beam is white light and the three color bands derived therefrom are Red, Green and Blue (labeled as R, G, and B respectively in FIGS. 1-4). As shown in FIG. 1, the first color sequence is an ordered succession of Green, Red and Green color bands, whereas the second color sequence is an ordered succession of Red, Blue and Blue color bands. In this manner, all three possible paired combinations of the three primary color bands are provided within the two color sequences, i.e. two colors per color sequence and one color (in this case Red) being shared between the color sequences.

When this embodiment is used in a two-panel light engine using two imagers, each imager will respectively receive one of the two light components sequentially colored by one of the two color sequences. This allows white-point balancing of the image frame by changing the amount of one of the three color bands relative to the other two, independent of the ratio between the amounts of the other two color bands.

It is to be noted that the color sequences shown in FIG. 1 represent only one possible arrangement for applying the principles of the present invention. Other alternative arrangements are also possible to implement without deviating form such principles. Examples of alternative arrangements include the ordered succession of color bands being of Green, Green and Red for the first color sequence, and of Blue, Red and Blue for the second color sequence, and so on. Furthermore, instead of sharing the Red color band between the two sequences, it is possible to have any one of the other two primary color bands (Green and Blue) as the shared color band.

FIG. 2 illustrates, in a block diagram, an optical apparatus for transforming an incident light beam 1 polarized in a first orientation of a first mode into a first light output dually polarized in different orientations, in accordance with another embodiment of the present invention. The optical apparatus includes a two-stage color and polarization switch 30, followed by a pair of color filters 53 and 54. The two-stage color and polarization switch 30 is shown in FIG. 2 as an ordered tandem combination of a first filter F1, a first switch S1, a filtering assembly 20, and a second switch S2. FIG. 2 also shows that the incident light beam 1 is received from the left by the first filter F1 and is processed throughout the optical apparatus 30 to cause the two light components to follow two color sequences in a certain color and polarization pattern according to the relative combined states of the first and second switches S1 and S2, as further described below.

The incident light beam 1 shown in FIG. 2 is in a first polarization mode of a first orientation, which in case is linear polarization mode of p-type orientation. It is white light defining the three primary color bands of Red, Green and Blue (labeled as R, G, and B respectively).

The first filter F1 is a retarder stack filter, which receives the incident light beam 1, and transforms the first orientation (p-type) of each of the three color bands into a second orientation (s-type), which is orthogonal to the first orientation. In other words, this filter rotates the polarization of a specific color-band by π/2 without affecting the adjacent bands, as described in more detail in Sharp G D and Birge J R: “Retarder Stack Technology for Color Manipulation”, SID Symposium, Vol. 30, p. 1072, (1999), the contents thereof are incorporated herein by reference. In the exemplary embodiment shown in FIG. 2, the first filter F1 does not effect the Red color band but rotates the polarization of the Green and Blue (i.e. Cyan) color bands by π/2. After this filter, the Red color band retains its p-polarized orientation whereas the Green and Blue color bands become s-polarized. One commercially available device suitable for use as the first filter F1 is the Red/Cyan Color Select® filter product from ColorLink®, Inc.

The next device is the first switch S1, which receives light from the first filter F1. The first switch S1 is a color switch for switching between transmission of red, green, and blue spectral bands as detailed in Sharp G D, Birge J R, Chen J, and Robinson M G: “High Throughput Color Switch for Sequential Color Projection”, SID '00 Digest, Vol. 31, p. 92, (2000), the contents thereof are incorporated herein by reference. This color switch uses a two-polarizer additive-mode design, with three retarder stack-based stages cascaded, each independently operating on an additive primary. The first switch S1 is electronically switchable between a first state (off) and a second state (on). It is passive in the off-state but rotates the Red and Blue color bands in the on-state by π/2 without affecting the Green color band. In other words, the off-state of the first switch S1 retains the received orientation of all three color bands, whereas the on-state transforms the p-type orientation of the Red color band into the s-type orientation, and the s-type orientation of the Blue color band into the p-type orientation, while retaining the s-type orientation of the Green color band.

In the embodiment shown in FIG. 2, the first switch S1 is formed of a switching element 13 positioned between a first and a second set of retarder layers 11 and 12. The switching element 13 is a transmissive liquid crystal device containing a plurality of liquid crystal switches for chromatically manipulating polarization. One commercially available device suitable for use as the first switch S1 is the Magenta Color Switch® product from ColorLink®, Inc. It is further desirable to have the first and second sets of retarder layers 11 and 12 index matched, i.e. by using antireflection coating, between the retarder layers and at the beginning and on the outside of the first switch S1, as required.

The filtering assembly 20 then receives light from the first switch S1, and transforms between the p-type and s-type orientations of each of the three color bands, while blocking the s-type orientation of the Red color band. In this embodiment, the filtering assembly 20 is formed of a second filter F2 positioned between two quarter-wave (π/4) plates designated as a first polarization converter 21 and a second polarization converter 22. The first polarization converter 21 converts the first (linear) polarization mode into a second (circular) polarization mode, such that the p-type and s-type orientations of the first polarization mode are respectively transformed into mutually orthogonal third (left-handed) and fourth (right-handed) orientations of the circular polarization mode. The second filter F2 is a cholesteric color filter that reflects a color band depending on the initial state of polarization thereof. In this embodiment, the Red color band gets reflected, hence blocked, when it is in right-handed circular polarized and gets transmitted otherwise, whereas the Blue and Green color bands are not affected by this filter. The second polarization converter 22 then reverts the circular polarization mode back into the linear polarization mode, such that the left-handed and right-handed circular polarizations are respectively transformed into the p-type and s-type linear polarization. Commercially available devices suitable for use as the second filter F2 include cholesteric color filters from Rolic Technologies Ltd. For more compact designs, the first filter F1 is integrated with the first set of retarder layers 11 into a single retarder stack, and the second set of retarder layers 12 is integrated with the first polarization converter 21 in a single retarder stack.

The second switch S2 is a liquid crystal switching element disposed to receive light from the filtering assembly 20. This switch is electronically switchable between a first state (off) and a second state (on). In its off-state the second switch S2 passes the light un-affected, thereby retaining the orientation of all three color bands. In its on-state the filter acts as a half-wave (π/2) plate and rotates the polarization by π/2, thereby transforming between the p-type and s-type orientations of each of three color bands.

The pair of color filters, including a third filter 53 and a fourth filter 54, then receive the first light output. The third filter 53 is a Yellow dichroic filter, which passes the Red and Green color bands and reflects back the Blue color band. The fourth filter 54 is a Magenta dichroic filter, which passes the Red and Blue color bands and reflects back the Green color band. This in effect produces a second light output having a p-polarized first light component and an s-polarized second light component, where both components have one of the three primary colors. Finally, the first light output is received by splitting means (not shown in FIG. 2) for directing the first and second orientations thereof into a first and a second light component following two diverse paths.

In this embodiment, the first light output follows a color and polarization sequence as determined by the combined states of the first switch S1 and the second switch S2 when synchronized with one another.

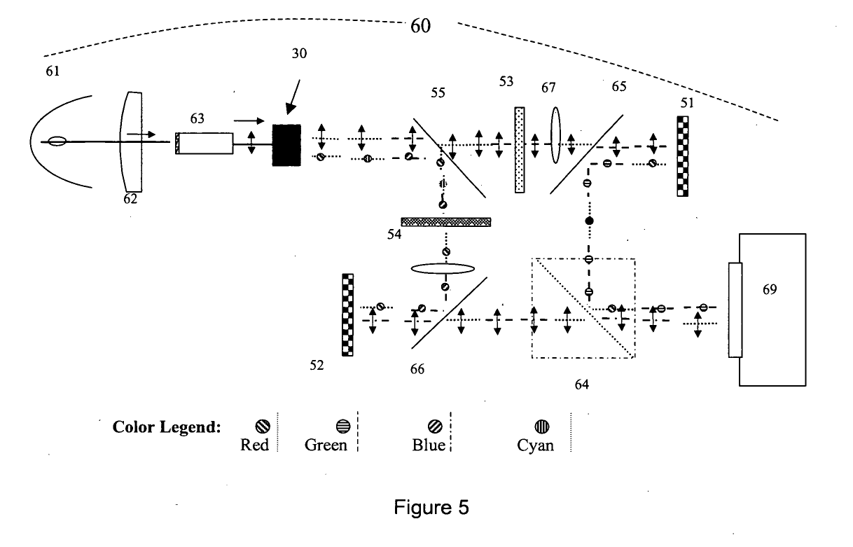

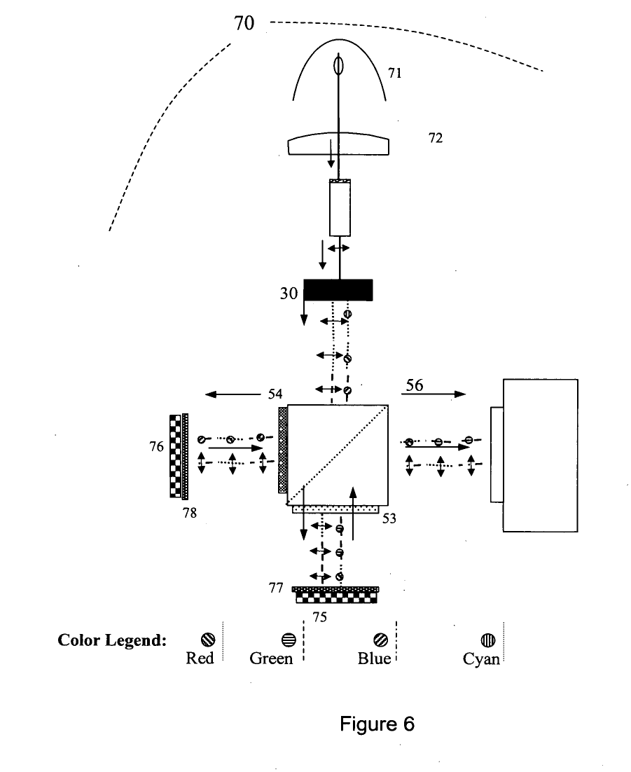

The first and second light components are then used in various embodiments of the present invention, as part of a light engine to illuminate two reflective imagers, which individually modulate over the frame interval the first and second light components according to an applied image signal, to generate two respective modulated light beams, which when directed into projection lens will create within the frame interval a colored image corresponding to the image signal. Two exemplary embodiments of such light engines are illustrated in FIGS. 5 and 6 as is described further below.

Alternative embodiments to that shown in FIG. 2 include additional filters to optimize the light engine performance. For example, at least one polarization filter is added to improve the quality of the colored image by cleaning up the polarization effect at various stages. Another example is to add at least one analyzer to increase contrast of the colored image. It is also possible to tailor the performance of various filters in order to optimize the light-engine performance. For example, a notch at the Orange color is possibly designed into the light engine by choosing the band edge of the first filter (Cyan retarder filter) and the Red edge of the fourth filter (dichroic Magenta filter) accordingly.

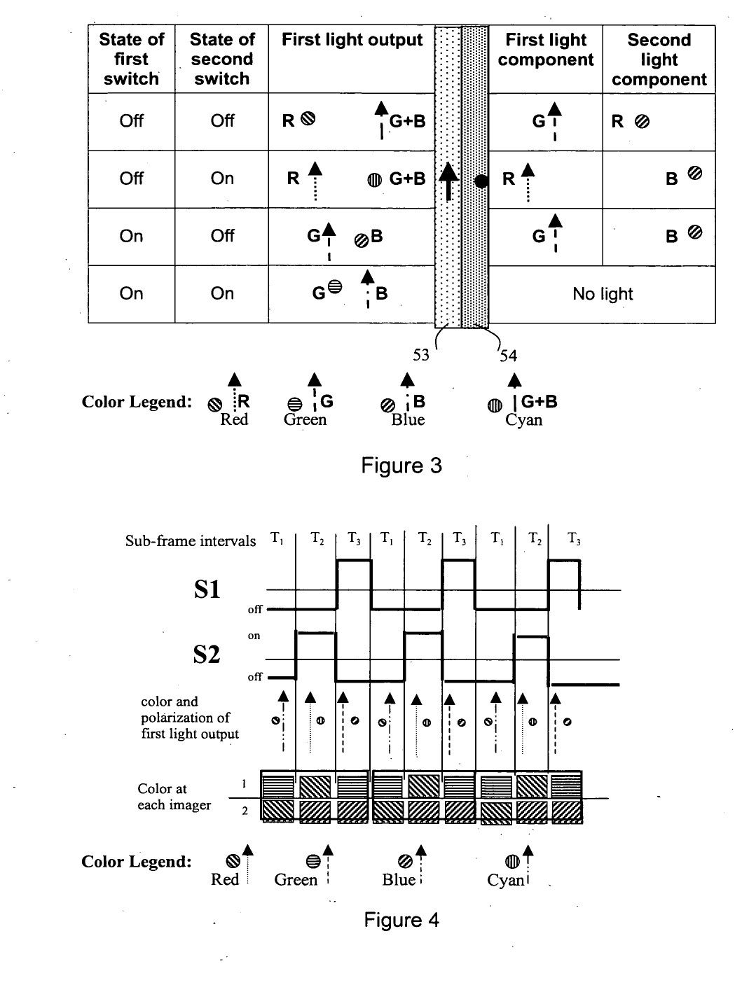

FIG. 3 illustrates in a table all four possible outcomes of the embodiment shown in FIG. 2 corresponding to all possible combined states of the first switch S1 and the second switch S2. The third column of FIG. 3 shows all four possible color and polarization states of the first output light emanating from the second switch S2, whereas the fourth column shows respective colors of the p-polarized first light component after the Yellow dichroic filter 53, and the fifth column shows respective colors of the s-polarized second light component after the Magenta dichroic filter 54.

The respective colors of the first and second light components shown in FIG. 3 are summarized as follows.

1) Green and Red when both first and second switches are turned off;

2) Red and Blue when the first switch is turned off and the second switch is turned on;

3) Green and Blue when the first switch is turned on and the second switch is turned off;

4) No light when both first and second switches are turned on.

In order to generate the two color sequences shown in FIG. 1, the first and second switches S1 and S2 need to be switched in synchronism over a the frame interval through the three switching combinations of:

a) both first and second switches turned off;

b) the first switch turned off and the second switch on; and

c) the first switch turned on and the second switch off.

The last state of both first and second switches being tuned on is not needed in typical situations, as no light will be produced by the two imagers of a two-panel light engine. There are certain circumstances, however, where dark images are needed to increase the dark state and the dynamic range (contrast ratio) in the light engine. For such circumstances, this switching-stage is used in an alternative embodiment of the present invention.

The above process is further illustrated in the timing diagram of FIG. 4 by showing the respective time sequences of the switching states of the first and second switches, the color and polarization states of the first light output and the respective colors of the two color sequences to illuminate the two reflective imagers, over each of the three sub-frame intervals within one frame interval. It is clear that the resulting color sequences for the first and second imagers are the same as those shown in FIG. 1, which satisfies the requirement for a true white-point balancing capability at a maximum duty cycle.

The following is a description of two exemplary embodiments of two-panel light engines shown in FIGS. 5 and 6, which make use of the optical apparatus embodiment illustrated in FIG. 2. The light engine embodiment of FIG. 5 uses a wire-grid type polarizing beam splitter 55 as the splitting means mentioned above, whereas the embodiment of FIG. 6 uses a polarizing beam splitting cube 56 instead.

In the embodiment of FIG. 5, a light engine 60 includes an arc lamp 61 to radiate white light into a condenser lens 62, which in turn beams the white light onto a Polarization conversion light pipe 63, for emitting a linearly polarized white incident light in p-type orientation towards the two-stage color and polarization switch 30 of the optical apparatus shown in FIG. 2. The two-stage switch 30 receives the linearly polarized p-type white light and produces a first light output linearly polarized in dual p-type and s-type orientations, in accordance with the principles of the present invention described above. A first beam-splitter 55 of the wire grid type polarizing type then receives this light and splits it into a p-polarized first light component passing towards the Yellow dichroic filter 53 and an s-polarized second light component reflected onto a Magenta dichroic filter 54, both filters being part of the optical apparatus shown in FIG. 2.

The p-polarized first light component then passes through the Yellow filter 53 after having its Blue color band blocked, onward to a relay lens 67 and then passes through a second wire grid type polarizing beam-splitter 65 onto a first LCoS reflective imager 51. The p-polarized light is then modulated by the first imager 51 and is reflected back as s-polarized light towards the beam-splitter 65 to be reflected towards a polarizing beam splitting cube 64, where it is reflected again onto a projection lens 69.

At the same time, the s-polarized second light component passes through the Magenta filter 54 after having its Green color band blocked, onward to another relay lens 68 and is then reflected by a third wire grid type polarizing beam-splitter 66 towards a second LCoS reflective imager 52. The s-polarized light is then modulated by the second imager 52 and is reflected back as p-polarized light, passes through the third beam-splitter 66 and then through the polarizing beam splitting cube 64 onto the projection lens 69.

Over each frame interval corresponding to one image frame, the first and second imagers 51 and 52 individually modulate the first and second light components according to the applied image signal in order to generate a first and a second modulated light beam which are directed onto the projection lens 69 to create within the frame interval a colored image corresponding to the image signal.

In the embodiment of FIG. 6, a light engine 70 includes an arc lamp 71 to radiate white light into a condenser lens 72, which in turn beams the white light onto a polarization conversion light pipe 73, for emitting a linearly polarized white incident light in p-type organization towards the two-stage color and polarization switch 30 of the optical apparatus shown in FIG. 2. This two-stage switch 30 receives the linearly polarized p-type white light and produces a first light output linearly polarized in dual p-type and s-type orientations, in accordance with the principles of the present invention described above. A polarizing beam splitting cube 56 then receives this light and splits it into a p-polarized first light component passing towards the Yellow dichroic filter 53 and an s-polarized second light component reflected onto a Magenta dichroic filter 54, both filters being part of the optical apparatus shown in FIG. 2.

The p-polarized first light component then passes through the Yellow filter 53 after having its Blue color band blocked, onward to a quarter-wave plate (λ/4) 77 followed by a first LCoS reflective imager 75. The p-polarized light is then modulated by the first imager 75 and is reflected back as s-polarized light towards the beam splitting cube 56 to be reflected towards a projection lens 79.

At the same time, the s-polarized second light component passes through the Magenta filter 54 after having its Green color band blocked, onward to another quarter-wave plate (λ/4) 78 followed by a second LCoS reflective imager 76. The s-polarized light is then modulated by the second imager 76 and is reflected back as p-polarized light to pass through the beam splitting cube 56 onto the projection lens 79.

Over each frame interval corresponding to one image frame, the first and second imagers 75 and 76 individually modulate the first and second light components according to the applied image signal in order to generate a first and a second modulated light beam which are directed onto the projection lens 79 to create within the frame interval a colored image corresponding to the image signal.

For practical consideration, it is often desirable to directly mount the optical apparatus 30 on one side of the polarizing beam splitting cube 56 facing the two-stage switch 30 as well as to mount the Yellow and Magenta filters 53 and 54 on two other sides facing the first and second imagers 75 and 76 respectively, as illustrated in FIG. 6.

The above-described embodiments are intended to be examples of the present invention. Numerous variations, modifications, and adaptations may be made to the particular embodiments by those of skill in the art, without departing from the spirit and scope of the invention, which are defined solely by the claims appended hereto.

What is claimed is:

1. An optical apparatus for transforming an incident light beam polarized in a first orientation of a first mode into a first light output dually polarized in a first and a second orientation of the first mode, the second orientation being substantially orthogonal to the first orientation, the incident light beam defining a first, a second and a third color band, the apparatus comprising:
a first filter for receiving the incident light beam, and transforming the first orientation of each of the second and third color bands into the second orientation;
a first switch disposed to receive light from the first filter, the first switch being electronically switchable between a first state for retaining the first orientation of all three color bands, and a second state for transforming the first orientation of the first color band into the second orientation, and the second orientation of the third color band into the first orientation;
a filtering assembly disposed to receive light from the first switch for blocking the second orientation of the first color band, otherwise transforming each of the three color bands between the first and second orientations; and
a second switch disposed to receive light from the filtering assembly, the second switch being electronically switchable between a first state for retaining the orientation of all three color bands, and a second state for transforming each of three color bands between the first and second orientations;
wherein in operation, the first and second states of each of the first and second switches are synchronized such that the first light output follows a predetermined color and polarization sequence.

2. The optical apparatus of claim 1, wherein the first filter is a retarder stack filter.

3. The optical apparatus of claim 1, wherein the first switch comprises a liquid crystal transmissive device containing a plurality of liquid crystal switches, the transmissive device positioned between a first and a second set of retarder layers.

4. The optical apparatus of claim 3, wherein the first filter is integrated with the first set of retarder layers into a single retarder stack.

5. The optical apparatus of claim 1, wherein the incident light beam is white light, and the first, second and third color bands are substantially the red, green and blue primary color bands.

6. The optical apparatus of claim 1, further comprising means for white-point balancing by changing the amount of one of the three color bands relative to the other two color bands, independent of the ratio between the amounts of the other two color bands.

7. The optical apparatus of claim 1, wherein the filtering assembly comprises a second filter positioned between a first and a second polarization converter wherein:
the first polarization converter converts the first polarization mode of light received from the first switch into a second polarization mode, such that the first and second orientations of the first polarization mode are respectively transformed into mutually orthogonal third and fourth orientations of the second polarization mode;
the second filter blocks the fourth orientation of first color band; and
the second polarization converter reverts the second polarization mode into the first polarization mode, such that the third and fourth orientations are respectively transformed into the first and second orientations.

8. The optical apparatus of claim 7, wherein the first polarization mode is linear, the first and second orientations are of p-type and s-type respectively, the second polarization mode is circular, and the third and fourth orientations are of left-handedness and right-handedness respectively.

9. The optical apparatus of claim 8, wherein the second filter is a cholesteric color filter.

10. The optical apparatus of claim 8, wherein the first switch comprises a switching element positioned between a first and a second set of retarder layers.

11. The optical apparatus of claim 10, wherein the second set of retarder layers is integrated with the first polarization converter in a single retarder stack.

12. The optical apparatus of claim 1, further comprising:
a pair of color filters disposed to receive the first light output, for blocking the third and second color bands, thereby transmitting in combination a second light output having:
the second color band polarized in the first orientation and the first color band in the second orientation when each of the first and second switches is in the first state thereof;
the first color band polarized in the first orientation and the third color band in the second orientation when the first switch is in the first state thereof and the second switch is in the second state thereof; and
the second color band polarized in the first orientation and the third color band in the second orientation band when the first switch is in the second state thereof and the second switch is the first state thereof.

13. The optical apparatus of claim 12, wherein the pair of color filters are dichroic color filters.

14. The optical apparatus of claim 12, wherein the incident light beam is white light, the first, second and third color bands are substantially the red, green and blue primary color bands, and the pair of color filters comprise a yellow filter and a magenta filter.

15. The optical apparatus of claim 12, wherein in operation the first and second switches are switched over a predetermined frame interval through three switching combinations of:
the first switch being in the first state thereof and the second switch in the first state thereof;
the first switch being in the first state thereof and the second switch in the second state thereof;
the first switch being in the second state thereof and the second switch in the first state thereof;
thereby providing over the frame interval all three paired combinations of the first, second and third color bands within the first and second orientations of the light output.

16. The optical apparatus of claim 1, further comprising:
splitting means disposed to receive the first light output, for splitting the first and second orientations thereof into a first and a second light component.

17. A light engine comprising:
a projection lens;
the optical apparatus of claim 15;
splitting means disposed to receive the second light output, for splitting the first and second orientations into a first and a second light component respectively;
a first and a second imager positioned to receive and individually modulate over the frame interval the first and second light components respectively, according to an applied image signal, thereby generating a first and a second modulated light beam; and
means for directing the first and second modulated light beams into the projection lens;
thereby creating within the frame interval a colored image corresponding to the image signal.

18. A method for transforming an incident light beam into two sequentially colored light components over a predetermined frame interval, the method comprising the step of processing the incident light beam to form the two light components as two mutually synchronized sequences of three colored light pulses over the frame interval, each light pulse having one of three color bands derived from the incident light beam, wherein only one of the three color bands is shared between the two color sequences, thereby providing all three paired combinations of the three color bands over the frame interval within the two light components.

19. The method of claim 18, wherein the two light components are polarized in mutually orthogonal orientations.

20. A method for creating a colored image, using two imagers, the method comprising the steps of:
illuminating the two imagers with the two light components obtained by the method of claim 18 respectively, wherein the two imagers are operable to respectively modulate the two light components according to an applied image signal to generate two modulated light beams over the frame interval; and
directing the two modulated light beams into a projection lens.
